(19) United States
(12) Patent Application Publication
(10) Pub. No.: US 2004/0216938 A1
(43) Pub. Date: Nov. 4, 2004

(54) Caterpillar scooter

(76) Inventor: Chien-Chang Ho, Taichung (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/427,640

(22) Filed: May 1, 2003

(51) Int. Cl. B62M 7/00

(52) U.S. Cl. 180/219

(57) ABSTRACT

A caterpillar scooter includes a frame, a steering mechanism, a front wheel, a rear wheel, a motor, a caterpillar system and a transmission. The steering mechanism is connected with the frame. The front wheel is connected with the steering mechanism. The rear wheel is mounted on the frame. The motor is mounted on the frame. The caterpillar system is arranged about the rear wheel for rolling on the ground. The transmission transmits power from the motor to the caterpillar system.

### FIELD OF INVENTION

The present invention relates to a caterpillar scooter.

### BACKGROUND OF INVENTION

Taiwanese Patent Publication No. 463774 discloses a power skateboard 1 including a rear fork (consisting of two beams 20), a wheel 16 mounted on the rear fork for rolling the ground, an engine 40 mounted on the rear fork for driving the wheel 16 and a tank 50 mounted on the rear fork 20 for storing fuel to be supplied to the engine 40. The wheel 16 however gets stuck in sand and mud. Furthermore, the wheel 16 may be pierced by means of sharp objects on the ground.

The present invention is therefore intended to obviate or at least alleviate the problems encountered in prior art.

### SUMMARY OF INVENTION

It is the primary objective of the present invention to provide a caterpillar scooter.

According to the present invention, a caterpillar scooter includes a frame, a steering mechanism, a front wheel, a rear wheel, a motor, a caterpillar system and a transmission. The steering mechanism is connected with the frame. The front wheel is connected with the steering mechanism. The rear wheel is mounted on the frame. The motor is mounted on the frame. The caterpillar system is arranged about the rear wheel for rolling on the ground. The transmission transmits power from the motor to the caterpillar system.

Other objects, advantages, and novel features of the invention will become more apparent from the following detailed description when taken in conjunction with the attached drawings.

### BRIEF DESCRIPTION OF DRAWINGS

The present invention will be described through detailed illustration of embodiments referring to the drawings.

FIG. 1 is a perspective view of a caterpillar scooter according to a first embodiment of the present invention.

FIG. 2 is a top view of a portion of the caterpillar scooter shown in FIG. 1.

FIG. 3 is a side view of a portion of the caterpillar scooter shown in FIG. 1.

FIG. 4 is similar to FIG. 3 but showing the caterpillar scooter in a second position.

FIG. 5 is a perspective view of a caterpillar scooter according to a second embodiment of the present invention.

FIG. 6 is a side view of a portion of the caterpillar scooter shown in FIG. 5.

FIG. 7 is a side view of a portion of a caterpillar scooter according to a third embodiment of the present invention.

### DETAILED DESCRIPTION OF EMBODIMENTS

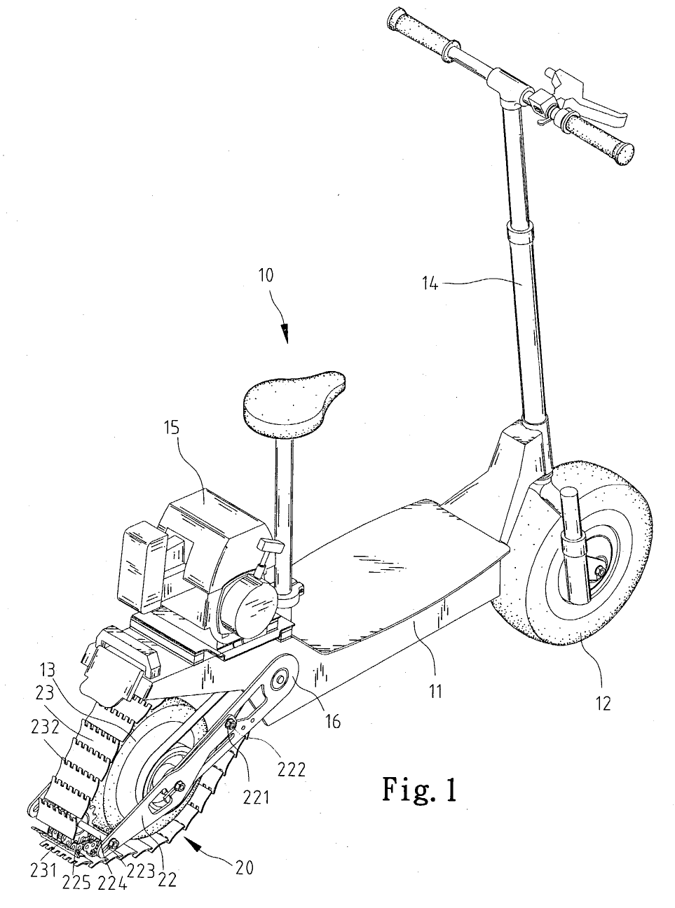

Referring to FIGS. 1-4, according to a first embodiment of the present invention, a caterpillar scooter consists of a power skateboard 10 and a caterpillar system 20.

In the preferred embodiment, the caterpillar scooter is built via modifying the power skateboard 10 because of its miniature and compact structure; however it may be built via modifying any other proper structures.

The power skateboard 10 includes a frame 11, a steering mechanism 14 installed at a front end of the frame 11, a front wheel 12 connected with the steering mechanism 14, two beams 16 pivotally mounted on the frame 11, a cushion 17 arranged between the frame 11 and one of the beams 16, a shaft 18 supported by means of the beams 16, a rear wheel 13 mounted on the shaft 18, and a motor 15 mounted on the frame 11.

The motor 15 may be an electric motor or an engine.

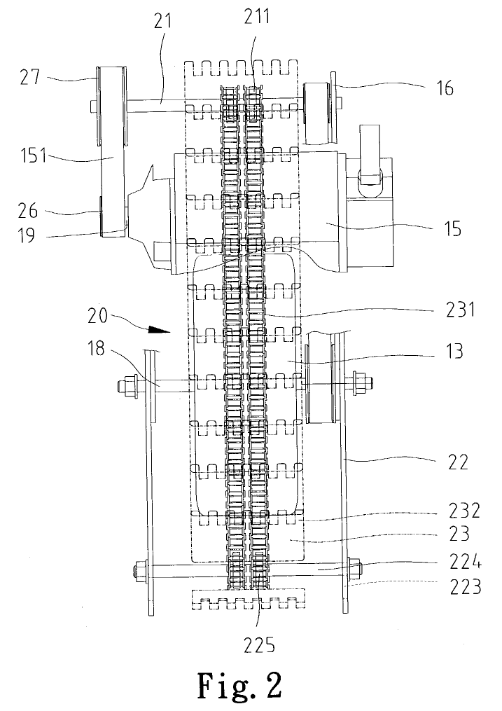

Referring to FIG. 2, the caterpillar system 20 includes a shaft 21 mounted on the frame 11, two sprockets 211 mounted on the shaft 21, a shaft 224 mounted on two beams 22 each connected with one of the beams 16, two sprockets 225 mounted on the shaft 224, a caterpillar 23 wound about the sprockets 211 and 225 and the rear wheel 13, and two chains 231 formed on an internal face of the caterpillar 23 and engaged with the sprockets 211 and 225.

Power is transmitted from the motor 15 to the caterpillar system 20 via a transmission. The motor 15 includes a shaft 19. The transmission includes a pulley 26 attached to the shaft 19, a pulley 27 mounted on the shaft 21 and a belt 151 wound about the pulleys 26 and 27.

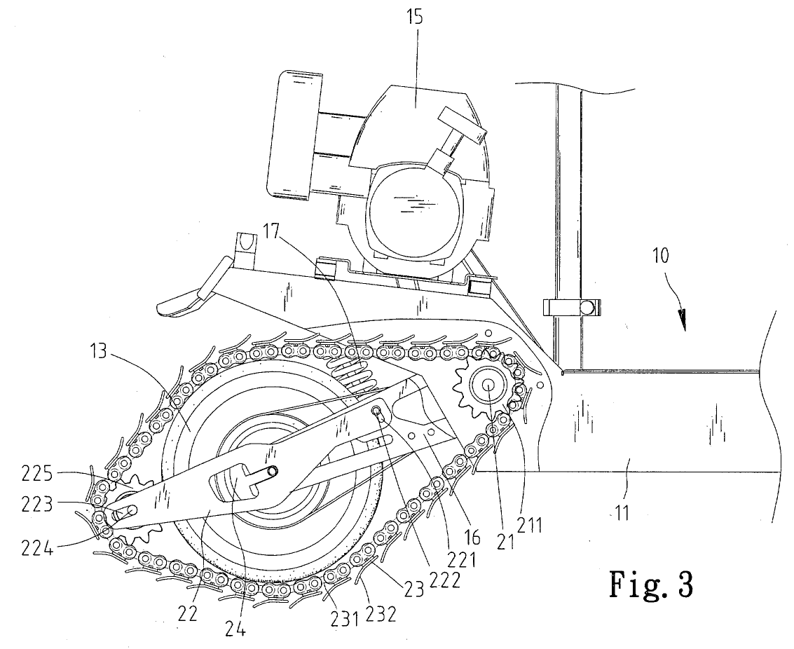

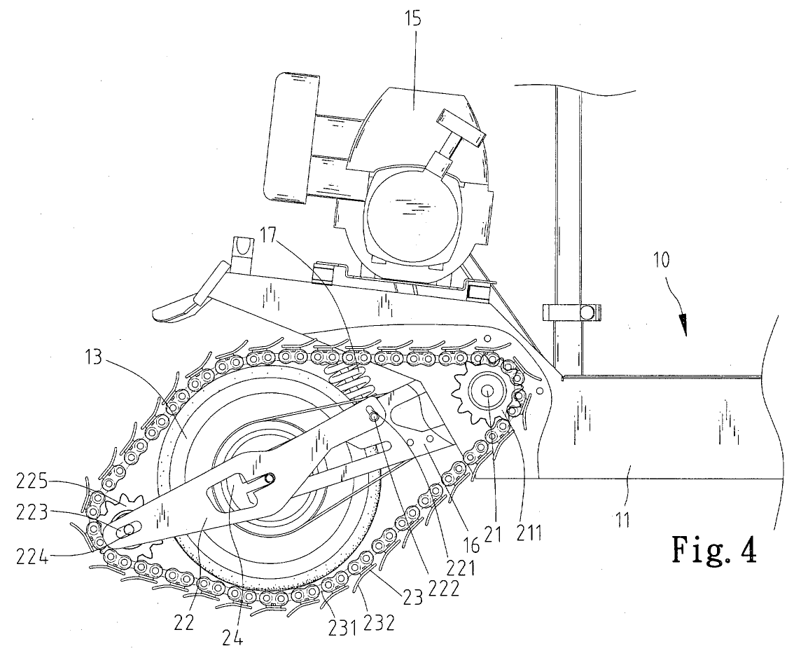

Referring to FIGS. 3 and 4, each of the beams 22 defines an opening 24, a slot 221 and a slot 223 so that the opening 24 is located between the slots 221 and 223. The shaft 18 is inserted in the openings 24 of the beams 22 and recesses (not shown) defined in the beams 16. A bolt 222 is inserted in the slots 221 of the beams 22 and apertures (not shown) defined in the beams 16. The slot 221 allows pivotal of the beams 22 relative to the beams 16. A shaft 224 is inserted in the slots 223 of the beams 22. The sprockets 225 are mounted on the shaft 224.

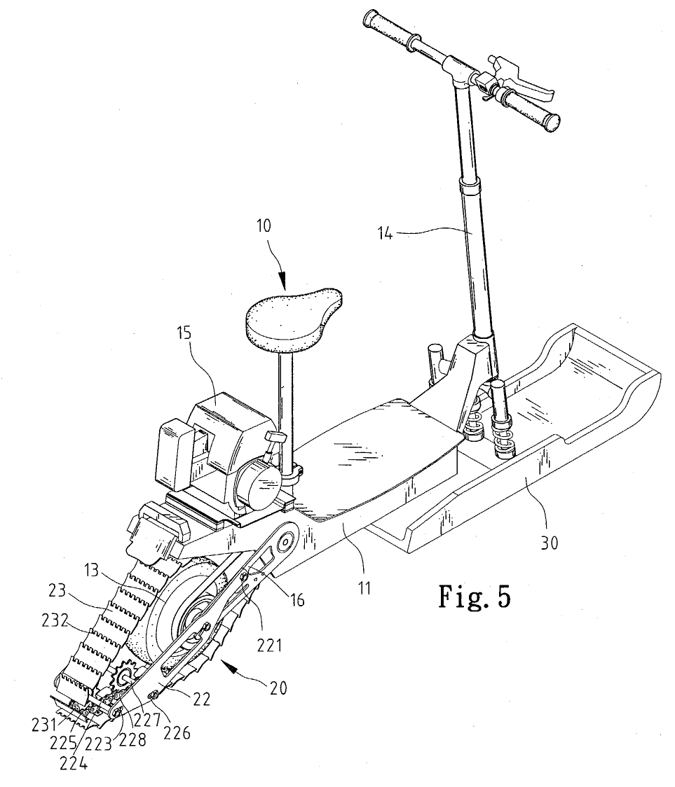

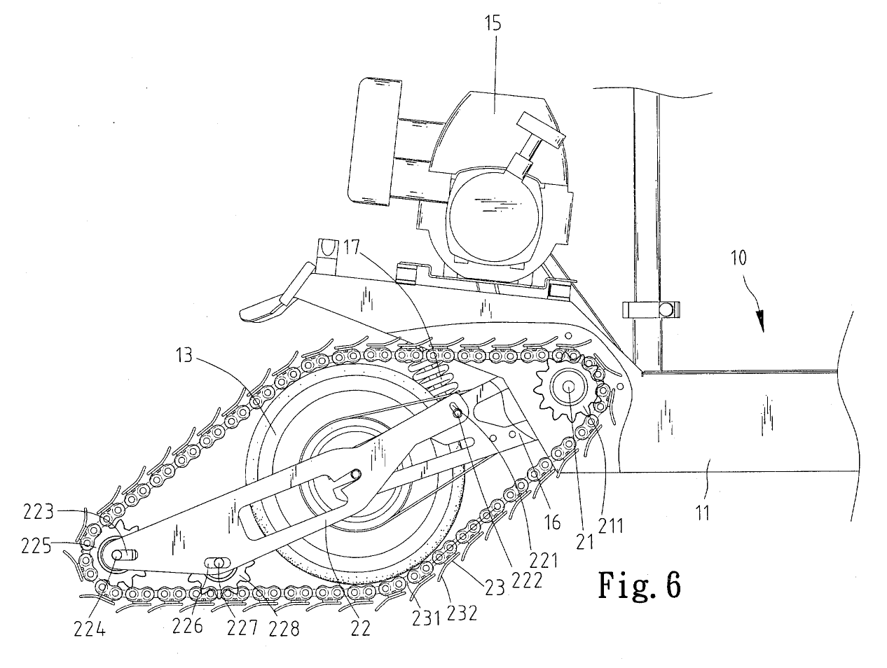

FIGS. 5 and 6 show a second embodiment according to the present invention. The second embodiment is identical to the first embodiment except for three aspects. Firstly, the front wheel 12 is replaced with a ski. Secondly, the caterpillar system 20 includes only one chain 231 and only one sprocket 225. Thirdly, the caterpillar system 20 includes an additional sprocket 228 for engagement with the chain 231. With the additional sprocket 228, the area of interface between the caterpillar 23 and the ground is increased, thus reducing the possibility of slipping. To this end, each of the beams 22 defines an additional slot 226 for receiving an additional shaft 227 on which the sprocket 228 is mounted.

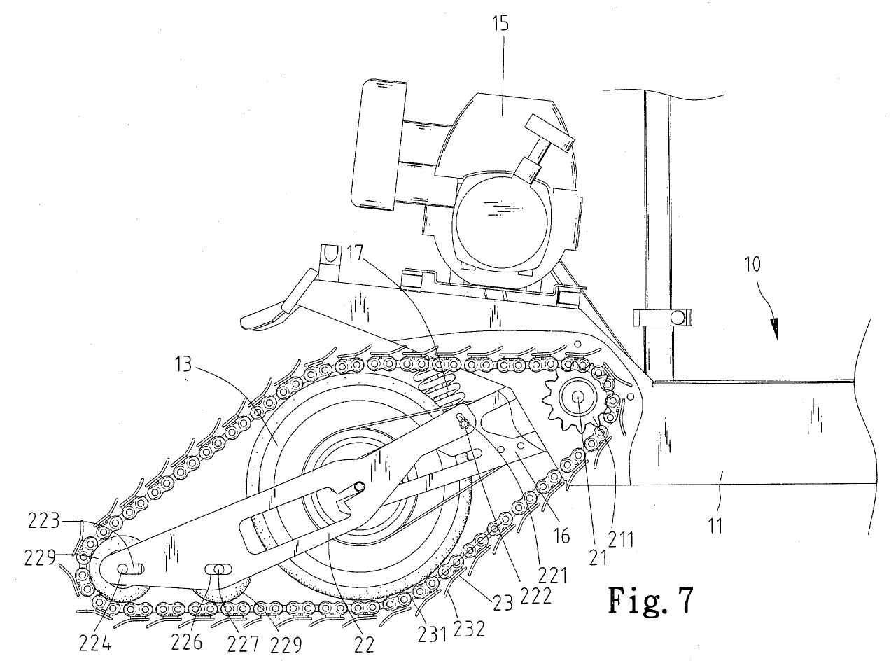

FIG. 7 shows a third embodiment according to the present invention particularly suitable for movement in mud. The third embodiment is identical to the second embodiment except that the sprockets 225 and 228 are replaced with wheels 229.

The present invention has been described via detailed illustration of two embodiments. Those skilled in the art can derive variations from the embodiments without departing from the scope of the present invention. Therefore, the embodiments shall not limit the scope of the present invention defined in the claims.

What is claimed is:

1. A caterpillar scooter including:
a frame;
a steering mechanism connected with the frame;
a front wheel connected with the steering mechanism;
a rear wheel mounted on the frame;
a motor mounted on the frame;
a caterpillar system arranged about the rear wheel for rolling on the ground; and
a transmission for transmitting power from the motor to the caterpillar system.

2. The caterpillar scooter according to claim 1 including two beams pivotally mounted on the frame for supporting the rear wheel.

3. The caterpillar scooter according to claim 2 including a cushion arranged between the frame and one of the beams.

4. The caterpillar scooter according to claim 2 including a rear shaft supported by means of the beams, wherein the rear wheel is mounted on the rear shaft.

5. The caterpillar scooter according to claim 1 wherein the motor is an electric motor.

6. The caterpillar scooter according to claim 1 wherein the motor is an engine.

7. The caterpillar scooter according to claim 1 wherein the caterpillar system includes:
a first roller mounted on the frame and operatively connected with the transmission;
a second roller mounted on the frame; and
a caterpillar wound about the rollers and the rear wheel.

8. The caterpillar scooter according to claim 7 including a chain formed on an internal face of the caterpillar, wherein the rollers are sprockets engaged with the chain.

9. The caterpillar scooter according to claim 7 including two beams connected with the frame for bearing the second roller.

10. The caterpillar scooter according to claim 9 including a shaft mounted on the beams for bearing the second roller.

11. The caterpillar scooter according to claim 8 wherein each of the beams defines a slot for receiving the shaft.

12. The caterpillar scooter according to claim 7 wherein the transmission includes a first pulley connected with the motor, a second pulley connected with the first roller and a belt wound about the pulleys.

13. The caterpillar scooter according to claim 1 including two first beams connected with the frame for supporting the rear wheel and two second beams connected with the first beams for supporting the caterpillar system.

14. The caterpillar scooter according to claim 13 wherein the caterpillar system includes:
a first roller mounted on the frame and operatively connected with the transmission;
a second roller mounted on the second beams; and
a caterpillar wound about the rollers and the rear wheel.

15. The caterpillar scooter according to claim 14 including a shaft mounted on the second beams, wherein the second roller is mounted on the shaft.

16. The caterpillar scooter according to claim 15 wherein each of the second beams defines a slot for receiving the shaft.

17. The caterpillar scooter according to claim 14 wherein the transmission includes a first pulley connected with the motor, a second pulley connected with the first roller and a belt wound about the pulleys.

18. The caterpillar scooter according to claim 1 wherein the caterpillar system includes:
a first roller mounted on the frame and operatively connected with the transmission;
a second roller mounted on the frame;
a third roller; and
a caterpillar wound about the rollers and the rear wheel.

19. The caterpillar scooter according to claim 18 including a chain formed on an internal face of the caterpillar, wherein the rollers are sprockets engaged with the chain.

20. A caterpillar scooter including:
a frame;
a steering mechanism connected with the frame;
a ski connected with the steering mechanism;
a rear wheel mounted on the frame;
a motor mounted on the frame;
a caterpillar system arranged about the rear wheel for rolling on the ground; and
a transmission for transmitting power from the motor to the caterpillar system.
